(19) United States
(12) Patent Application Publication
(10) Pub. No.: US 2006/0085476 A1
(43) Pub. Date: Apr. 20, 2006

(54) METHOD AND SYSTEM TO IDENTIFY A PREVIOUSLY VISITED UNIVERSAL RESOURCE LOCATOR (URL) IN RESULTS FROM A SEARCH

(75) Inventors: Fonda J. Daniels, Cary, NC (US); Timothy E. Figgins, Raleigh, NC (US); David B. Kumhyr, Austin, TX (US)

Correspondence Address: MOORE & VAN ALLEN, PLLC, P.O. Box 13706, Research Triangle Park, NC, 27709, US

(73) Assignee: INTERNATIONAL BUSINESS MACHINES CORPORATION, Armonk, NY (US)

(21) Appl. No.: 10/711,954

(22) Filed: Oct. 15, 2004

(51) Int. Cl. G06F 17/00

(52) U.S. Cl. 707/104.1

(57) ABSTRACT

A method to identify a previously visited URL in results from a search may include loading a URL personal databook collection object. The method may also include identifying any matches between results from the search and any URL object references in the URL personal databook collection object.

### BACKGROUND OF INVENTION

The present invention relates to performing searches on a network, such as the Internet, private networks or the like and more particularly to a method and system to identify a previously visited or accessed universal resource locator (URL), network address or the like in results from a search.

When a web page is “bookmarked,” a web browser typically saves or remembers that web page's address (URL) in an address book, list of favorites or the like. The web page may then be easily accessed in the future by “clicking on” or otherwise activating an identifying mark, short description or symbol (“bookmark”) associated with the URL in the address book using a computer pointing device or similar device. Bookmarks may be quite convenient for returning generally to a URL on a permanent/regular basis. However, for quick reference to specific information that may be relevant at any particular point in time, bookmarks may not be appropriate. For example, if a telephone number for a doctor or business is searched via a web browser, search items or keywords, such as the doctor's name or name of the business, may be entered in a search engine, such as Google®, yahoo.com® or the like. The returned search results may be evaluated to find the desired information or information of interest. After locating the information of interest (the telephone number for the doctor or business), the doctor or business may be called or contacted. In most cases, the URL for the doctor or business would not be bookmarked because this information can be quickly accessed via the web browser and the information does not warrant being permanently preserved. When the doctor or business may be called or contacted in the future, the search terms may simply be re-entered in the search engine and the steps above followed.

Some current web browsers may signal that the user has previously visited or accessed a URL by presenting the URL in a drop down list or in a different font color. However, the user is not able to identify a specific URL that previously referenced the desired information or why the user may have previously visited the URL or site.

### SUMMARY OF INVENTION

In accordance with an embodiment of the present invention, a method to identify a previously visited URL, web address or the like in results from a search may include loading a URL or address personal databook collection object. The method may also include identifying any matches between results from the search and any URL object references or the like in the URL personal databook collection object. Accordingly, as results from a query or search are displayed or re-displayed, indicators are provided to signal a user that from the list of URLs, web addresses or the like returned via the search engine, there exists at least one specific previously visited URL that provided the user the information they specifically needed or desired relative to search terms used for the search.

In accordance with another embodiment of the present invention, a method to identify a previously visited URL in results from a search may include comparing the results from the search to any URL object references in a URL personal databook collection object. The method may also include identifying visually any matches between the results from the search and any URL object references in the URL personal databook collection object.

In accordance with another embodiment of the present invention, a system to identify a previously visited URL in results from a search may include a data structure operable on a processor to compare results from the search to any URL references stored in a URL personal databook collection object. The method may also include a data structure to identify any matches between the results from the search and any URL references stored in the URL personal databook collection object.

In accordance with another embodiment of the present invention, a method for making a system to identify a previously visited URL in results from a search may include providing a data structure operable on a processor to compare results from the search to any URL references stored in a URL personal databook collection object. The method may also include providing a data structure to identify any matches between the results from the search and any URL references stored in the URL personal databook collection object.

In accordance with another embodiment of the present invention, a computer-readable medium having computer executable-instructions may include comparing the results from the search to any URL object references in a URL personal databook collection object. The method may also include identifying visually any matches between the results from the search and any URL object references in the URL personal databook collection object.

### DESCRIPTION OF THE DRAWINGS

FIGS. 1A, 1B and 1C (collectively FIG. 1) are a flow chart of an example of a method to identify a previously visited URL in results from a search in accordance with an embodiment of the present invention.

FIG. 2 is an example of a graphical user interface (GUI), screen shot or the like illustrating results of a search and identifying any matches between the search results and any URL object references in a URL personal databook collection object in accordance with an embodiment of the present invention.

FIG. 3 is an example of a system to identify a previously visited URL in results from a search in accordance with an embodiment of the present invention.

### DETAILED DESCRIPTION

The following detailed description of preferred embodiments refers to the accompanying drawings, which illustrate specific embodiments of the invention. Other embodiments having different structures and operations do not depart from the scope of the present invention.

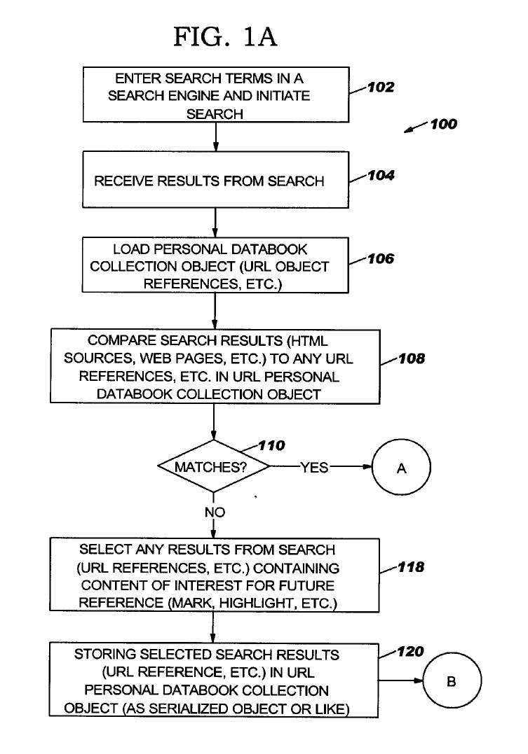

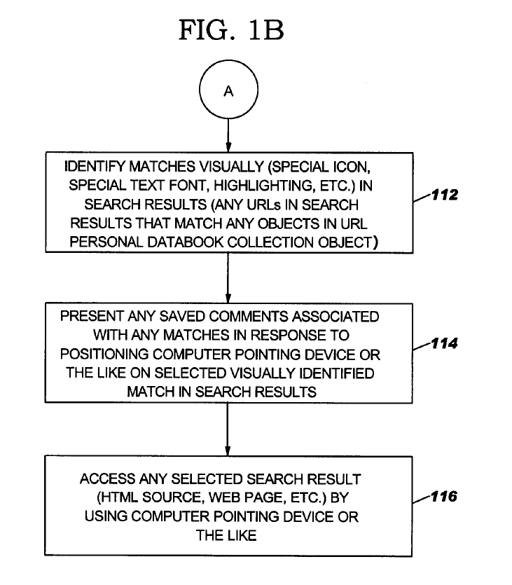

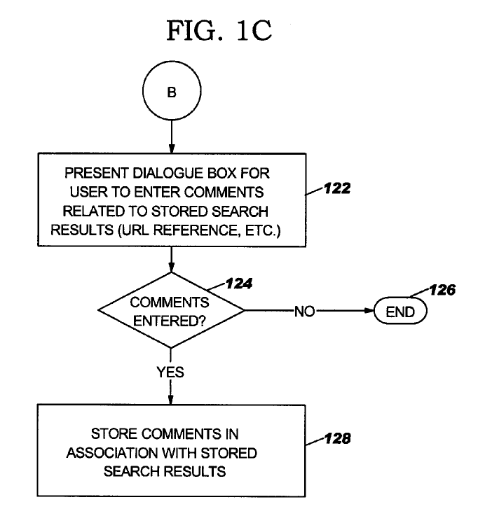

FIGS. 1A, 1B and 1C (collectively FIG. 1) are a flow chart of an example of a method 100 to identify a previously visited URL in results from a search in accordance with an embodiment of the present invention. In block 102, search terms, keywords or the like may be entered in a search engine by a user using a computer system, communications device or similar device, and a search of a network, such as the Internet, private network or the like, may be initiated. The search engine may be Google®, yahoo.com® or a similar search engine. In block 104, results from the search may be received. The search results may be presented to the user in a graphical user interface (GUI), web page or the like. In block 106, a personal databook collection object may be loaded. As the search results GUI or page is being rendered, a background application, data structure or program may load the URL personal databook collection object. As discussed in more detail below, the URL personal databook collection object may store URL object references, web addresses or the like that have been previously visited or accessed for specific content or information and have been selectively saved or loaded by a user into the URL personal databook collection object. The URL personal databook collection object may form part of the browser. Alternatively, the URL personal databook collection object may be a predetermined memory location or portion of a memory or stored on a data storage device or system memory of a computer system or the like. A URL object reference may be a web address, reference to a specific location or address on a network, such as the Internet, private network or other type network or system.

In block 108, the search results may be compared to any URL object references or the like in the URL personal databook collection object. The search results may be in the form of URLs, hypertext mark-up language (HTML) sources, web pages or the like.

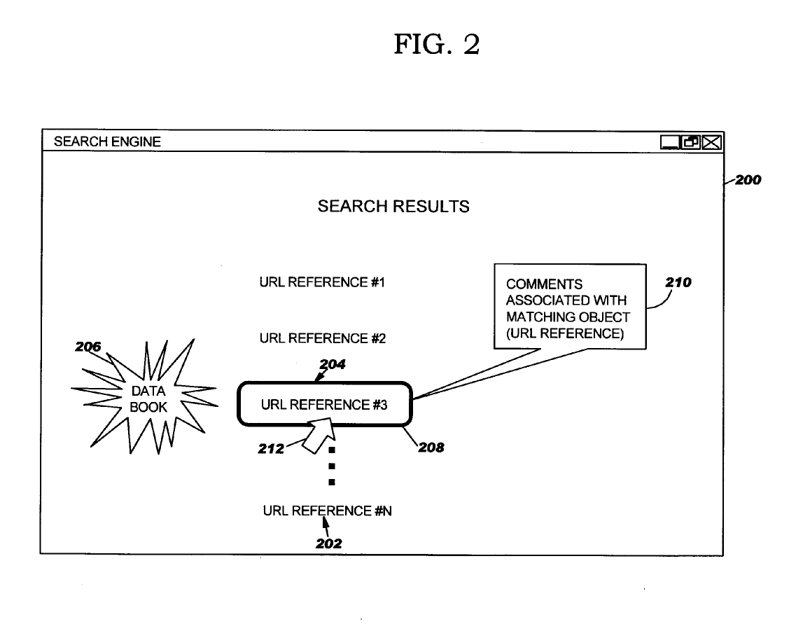

In block 110, a determination may be made whether there are any matches between results from the search and any URL object references or the like in the URL personal databook collection object from the comparison in block 108. If there are matches in block 110, the method 100 may advance to block 112 (FIG. 1B). In block 112, any matches may be visually identified in the search results. The matches may be visually identified by a special icon, special text font, highlighting or other means of bringing a user's attention to a match between the search results and any URL object references or the like stored in the URL personal databook collection object. Referring also to FIG. 2, FIG. 2 is an example of a graphical user interface 200, screen shot or the like illustrating results 202 of a search and identifying any matches 204 between the search results and any URL object references in a URL personal databook collection object in accordance with an embodiment of the present invention. As illustrated in FIG. 2, the match 204 may be identified visually by a special icon 206, special text font, for example bold as illustrated, highlighted, such as by a box 208 or the like.

In block 114 (FIG. 1B), any saved comments associated with any matches may be presented in response to positioning a computer pointing device, mouse or the like on a selected visually identified match in the search results. Referring also to FIG. 2, FIG. 2 illustrates a balloon 210 or the like to present any comments that may have been entered and saved by the user in association with a URL object reference previously saved or loaded in the URL personal databook collection object. The balloon 210 and comments may be presented in response to positioning a computer pointing device 212 or cursor on the visually identified match 204 in the search results 202. The comments may have been entered by a user to indicate a reason or the specific information why the URL object reference was stored or loaded into the URL personal databook collection object.

Referring back to FIG. 1B, in block 116, any results in the search may be selectively accessed using a computer pointing device or the like. The search result may be selected by clicking on the search result and activating a link or hyperlink to the URL or web site represented by the entry in the search results.

Referring back to FIG. 1A, if no matches are found between the search results and any URL object references in the URL personal databook collection object, the method 100 may advance to block 118. In block 118, any results from the search, such as URL references, web addresses or the like, containing content or information of interest may be selected for future reference or for other reasons or purposes. The selected results may be marked in some manner, such as by highlighting, changing the color of the font, a special icon, special font or the like. In block 120, the selected search results may be stored or loaded in the URL personal databook collection object. As previously discussed, the search result may be a URL reference, web address or similar designation for a location on a network that may be stored or loaded as a serialized object or the like.

In block 122 (FIG. 1C), a dialogue box or the like may be presented to the user to enter any comments related to the stored or loaded search results in block 120. As previously discussed, the comments may provide a reason why the search results were saved in the URL personal databook reference object or may provide a brief summary of the content or information of interest. In the event the URL reference or web address is retrieved again as part of a future search, the comments may be presented as described with respect to FIG. 2 to provide the user with a reminder of why the search results or URL object reference was saved or an indication of the content or information available at the URL or web address.

In block 124, a determination may be made as to whether comments were entered in block 122. If no comments were entered, the method 100 may end at termination 126. If a determination is made in block 124 that comments were entered in block 122, the comments may be stored in association with the selected and stored search results in block 128. The dialogue box in block 122 may include a radio button or the like labeled “Save” or the like that may be operated using a computer pointing device to save the comments in association with the corresponding search results.

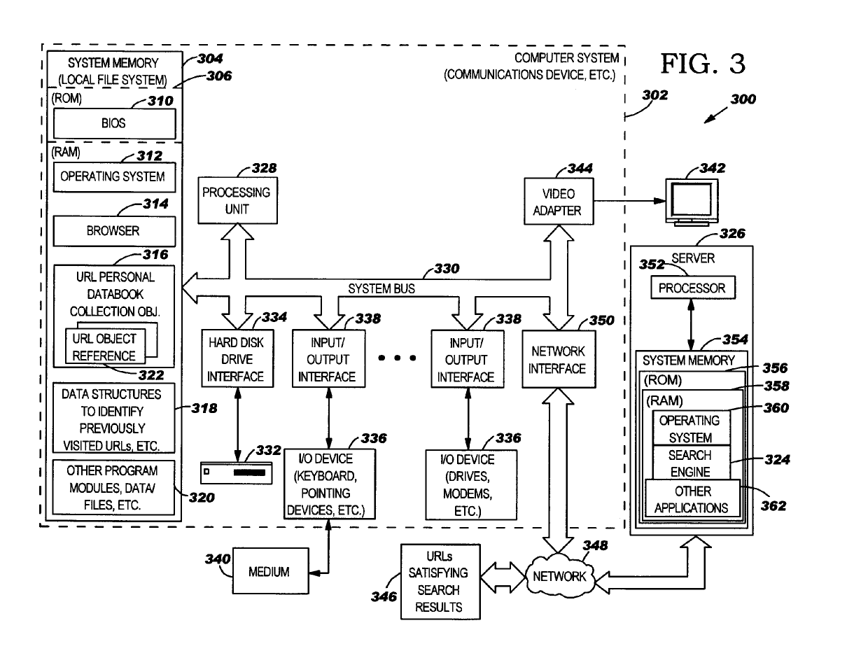

FIG. 3 is a block schematic diagram of an exemplary system 300 to identify a previously visited URL, web address or the like in results from a search in accordance with an embodiment of the present invention. The system 300 may include a computer system 302 or similar system or device. The computer system 302 may also be a communications device, such as a cellular telephone, mobile computing system, personal digital assistant or the like.

The computer system 302 may include a system memory or local file system 304. The system memory 304 may include a read only memory (ROM) 306 and a random access memory (RAM) 308. The ROM 306 may include a basic input/output system (BIOS) 310. The BIOS 310 may contain basic routines that help to transfer information between elements or components of the computer system 302. The RAM 308 may contain an operating system 312 to control overall operation of the computer system 302. The RAM 308 may also include a browser 314 or web browser, a URL personal data book collection object 316 and data structures 318 to identify a previously visited URL, web site or the like in accordance with an embodiment of the present invention. The RAM 308 may further include application programs and other program modules, data and other files 320.

Elements of the present invention described with respect to method 100 of FIGS. 1A, 1B and 1C may be embodied in the system 300 and in the browser 314, URL personal databook collection object 316 and data structures 318 to identify previously visited URLs. As previously discussed, the URL personal databook collection object may store URL object references 322, web addresses or the like that may have been loaded by a user to preserve a location or web address containing content or information of interest for future reference. The URL object references 322 may be used to compare against results of a search by a search engine, such as a search engine 324 on server 326, and to identify any matches similar to that described with respect to method 100.

The data structures 318 to identify a previously visited URL may include a data structure or code to compare results from a search to any URL references 322 stored in the URL personal databook collection object 316. The data structures 318 may also include a data structure or code to identify any matches between the results from the search and any URL references 322 stored in the URL personal databook collection object 316. Any matches may be identified visually similar to that described with respect to method 100.

The data structures 318 may further include a data structure or code to present any saved or captured comments associated with any URL references that match any search results. The comments may be presented or displayed in response to positioning a computer pointing device on a selected match in the search results similar to that described with respect to GUI 200 in FIG. 2.

The data structures 318 may additionally include a data structure or code to select any results from a search that contains content or information of interest for future reference or for other purposes. The data structures 318 may store the selected search results as URL object references 322 in the URL personal databook collection object 316 as previously described. Further, the structures 318 may include code to present a dialogue box for a user to enter and save any comments in association with the stored search results or URL object reference 322 similar to that discussed with respect to method 100 of FIGS. 1A, 1B and 1C.

The data structures 318 and the functionality associated therewith and the method 100 of FIGS. 1A-1C may be formed as part of the browser 314 and in one embodiment of the present invention may be implemented using Browser Help Objects (BHO) as described on the Microsoft® web page: http://msdn.microsoft.com/library/en-us/dnweben/html/bho.asp. With BHOs, components may be written, such as Component Object Model (COM) components or the like, that Microsoft Internet Explorer® may load each time the browser is loaded. Such objects may run in the same memory context as the browser and can perform any action on the available windows and modules. For example, a BHO may detect the browser's typical events, such as “GoBack,” “GoForward,” and “DocumentComplete.” The BHO may also access the browser's menu and toolbar and make changes; create windows to display additional information on a currently viewed page; and install hooks to monitor messages and actions.

The computer system 302 may also include a processor or processing unit 240 to control operations of the other components of the computer system 302. The operating system 312, browser 314, data structures 318 and other program modules 320 may be operable on the processing unit 328. The processing unit 328 may be coupled to the memory system 304 and other components of the computer system 302 by a system bus 330.

The computer system 302 may also include a hard drive 332. The hard drive 332 may be coupled to the system bus 330 by a hard drive interface 334. The hard drive 332 may also form part of the local file system 304 or system memory. Programs, software and data may be transferred and exchanged between the system memory 304 and the hard drive 332 for operation of the computer system 302.

The computer system 302 may also include multiple input devices, output devices or combination input/output devices 336. Each input/output device 336 may be coupled to the system bus 330 by an input/output interface 338. The input and output devices or combination I/O devices 336 permit a user to operate and interface with the computer system 302 and to control operation of the browser 314, URL personal databook collection object 316 and data structures 318 to identify a previously visited URL in search results. The I/O devices 336 may include a keyboard and computer pointing device or the like to perform the operations discussed above. The keyboard and pointing device 336 permit a user to enter search terms or keywords in the search engine 324 and to initiate a web search. The keyboard and pointing device 336 may also permit a user to select and store URL references or results from the search and to enter comments associated with any selected search results, as previously described. The I/O devices 336 also permit the URL personal databook object 316 and data structures 318 to be modified.

The I/O devices 336 may also include disk drives, optical, mechanical, magnetic, or infrared input/output devices, modems or the like. The I/O devices may be used to access a medium 340. The medium 340 may contain, store, communicate or transport computer-readable or computer-executable instructions or other information for use by or in connection with a system, such as the computer system 302.

The computer system 302 may also include or be connected to a display or monitor 342. The monitor 342 may be coupled to the system bus 330 by a video adapter 344. The monitor 254 may be used to permit the user to interface with the computer system 302. A form may be presented via the browser 314 by the search engine 324 on the monitor 342 for the user to enter search terms or keywords and results from the search may be presented on the monitor 342. The GUI 200 of FIG. 2 may be presented or displayed on the monitor 342.

The computer system 302 may communicate with the remote server 326 and access URLs 346 that may satisfy search results via a network 348. The system bus 330 may be coupled to the network 348 by a network interface 350. The network interface 350 may be a modem, Ethernet card, router, gateway or the like for coupling to the network 348. The coupling may be a wired connection or wireless. The network 348 may be the Internet or private network, such as an intranet or the like.

The server 326 may include a processor 352 to control operation of the server 326. The server 326 may also include a system memory 354. The system memory 354 may include a read only memory (ROM) 356 and random access memory (RAM) 358. ROM 356 and RAM 358 may be similar to ROM 306 and RAM 308 of computer system 302. The RAM 308 may include an operating system 360 to control operation of other components of the server 326. The RAM 308 may also include the search engine 324, as previously described, and other applications 362, program modules, files or the like.

Elements of the present invention, such as method 100 of FIGS. 1A-1C, and system 300 of FIG. 3, may be embodied in hardware and/or software as a computer program code that may include firmware, resident software, microcode or the like. Additionally, elements of the invention may take the form of a computer program product on a computer-usable or computer-readable storage medium having computer-usable or computer-readable program code embodied in a medium for use by or in connection with a system, such as system 300 of FIG. 3. Examples of such a medium may be illustrated in FIG. 3 as network 348 or medium 340 and I/O devices 336. A computer-usable or readable medium may be any medium that may contain, store, communicate or transport the program for use by or in connection with a system. The medium, for example, may be an electronic, magnetic, optical, electromagnetic, infrared or semiconductor system or the like. The medium may also be simply a stream of information being retrieved when the computer program product is “downloaded” through a network, such as the Internet or the like. The computer-usable or readable medium could also be paper or another suitable medium upon which the program may be printed.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method to identify a previously visited URL in results from a search, comprising:
loading a URL personal databook collection object; and
identifying any matches between results from the search and any URL object references in the URL personal databook collection object.

2. The method of claim 1, further comprising comparing the results from the search to any URL object references in the URL personal databook collection object to identify any matches.

3. The method of claim 1, further comprising identifying visually any matches in the results from the search.

4. The method of claim 3, further comprising visually identifying any matches by at least one of a predetermined icon, a predetermined text font and highlighting.

5. The method of claim 3, further comprising presenting any saved or captured comments associated with any matches in response to positioning a computer pointing device on a selected visually identified match in the results from the search.

6. The method of claim 1, further comprising selecting any results from the search containing content of interest for future reference in response to no matches.

7. The method of claim 6, further comprising storing any selected search results in the URL personal databook collection object.

8. The method of claim 7, wherein storing any selected search results comprises storing a URL reference.

9. The method of claim 8, further comprising storing the URL reference as a serialized object.

10. The method of claim 7, further comprising storing any comments in association with the stored search results.

11. A method to identify a previously visited URL in results from a search, comprising:
comparing the results from the search to any URL object references in a URL personal databook collection object; and
identifying visually any matches between the results from the search and any URL object references in the URL personal databook collection object.

12. The method of claim 11, further comprising loading the URL personal databook collection object in response to presenting the results from the search.

13. The method of claim 11, further comprising presenting any saved or captured comments associated with any matches in response to positioning a computer pointing device on a selected visually identified match in the results from the search.

14. The method of claim 11, further comprising:
selecting any results from the search containing content of interest for future reference in response to no matches; and
storing any selected search results in the URL personal databook collection object.

15. The method of claim 14, further comprising:
presenting a dialogue box to enter comments related to any stored search results; and
storing any comments in association with the stored search results.

16. A system to identify a previously visited URL in results from a search, comprising:
a data structure operable on a processor to compare results from the search to any URL references stored in a URL personal databook collection object; and
a data structure to identify any matches between the results from the search and any URL references stored in the URL personal databook collection object.

17. The system of claim 16, further comprising a data structure to identify visually any matches in the results from the search.

18. The system of claim 16, further comprising a data structure to present any saved or captured comments associated with any matches in response to positioning a computer pointing device on a selected visually identified match in the results from the search.

19. The system of claim 16, further comprising a data structure to select any results from the search containing content of interest for future reference in response to no matches.

20. The system of claim 19, further comprising a data structure to store any selected search results in the URL personal databook collection object.

21. The system of claim 20, further comprising a data structure to store and comments in association with the selected search results.

22. A method for making a system to identify a previously visited URL in results from a search, comprising:
providing a data structure operable on a processor to compare results from the search to any URL references stored in a URL personal databook collection object; and
providing a data structure to identify any matches between the results from the search and any URL references stored in the URL personal databook collection object.

23. The method of claim 22, further comprising providing a data structure to identify visually any matches in the results from the search.

24. The method of claim 22, further comprising providing a data structure to present any saved or captured comments associated with any matches in response to positioning a computer pointing device on a selected visually identified match in the results from the search.

25. The method of claim 22, further comprising providing a data structure to select any results from the search containing content of interest for future reference in response to no matches.

26. The method of claim 25, further comprising a data structure to store any selected search results in the URL personal databook collection object.

27. The method of claim 26, further comprising providing a data structure to store any comments in association with the selected search results.

28. A computer-readable medium having computer executable instructions for performing a method comprising:
comparing the results from the search to any URL object references in a URL personal databook collection object; and
identifying visually any matches between the results from the search and any URL object references in the URL personal databook collection object.

29. The computer-readable medium having computer executable instructions for performing the method of claim 28, further comprising loading the URL personal databook collection object in response to presenting the results from the search.

30. The computer-readable medium having computer executable instructions for performing the method of claim 28, further comprising presenting any saved or captured comments associated with any matches in response to positioning a computer pointing device on a selected visually identified match in the results from the search.

31. The computer-readable medium having computer executable instructions for performing the method of claim 28,
selecting any results from the search containing content of interest for future reference in response to no matches; and
storing any selected search results in the URL personal databook collection object.

32. The computer-readable medium having computer executable instructions for performing the method of claim 31,
presenting a dialogue box to enter comments related to any stored search results; and
storing any comments in association with the stored search results.
